(19) United States
(12) Patent Application Publication
(10) Pub. No.: US 2023/0119109 A1
(43) Pub. Date: Apr. 20, 2023

(54) SYSTEMS AND METHODS FOR CONTROLLING HALLUCINATIONS IN ABSTRACTIVE SUMMARIZATION

(71) Applicant: salesforce.com, inc., San Francisco, CA (US)

(72) Inventors: Prafulla Kumar Choubey, San Jose, CA (US); Nazneen Rajani, Mountain View, CA (US)

(21) Appl. No.: 17/586,467

(22) Filed: Jan. 27, 2022

Related U.S. Application Data
(60) Provisional application No. 63/252,507, filed on Oct. 5, 2021.

(51) Int. Cl. G06N 20/20; G06K 9/62; G06F 40/284

(52) U.S. Cl. CPC G06N 20/20; G06F 40/284; G06K 9/6259; G06K 9/6262

(57) ABSTRACT

Embodiments described herein provide a document summarization framework that controls different factual errors, referred to as “Mixture of Factual Experts (MoFE)” framework. MoFE applies an ensemble of factual expert models to control hallucination in summarization systems. Each factual expert model is trained to generate summaries with a unique type of factual quality. Factual consistency metrics may be used to filter training data in order to adjust the training inputs for each respective expert. The overall factual quality of MoFE may be achieved by controlling the relative weight of each factual expert. The experts may be ensembled (either through logits ensembling, or weighted average of parameters) in order to create a combined output that shares characteristics from each according to its relative weight.

### CROSS REFERENCES

The present disclosure is a nonprovisional of and claims priority under 35 U.S.C. 119 to U.S. Provisional Application No. 63/252,507, filed on Oct. 5, 2021, which is hereby expressly incorporated by reference herein in its entirety.

### TECHNICAL FIELD

The embodiments relate generally to machine learning systems and document summarization, and specifically to systems and methods for controlling hallucinations in abstractive summarization with enhanced accuracy.

### BACKGROUND

Abstractive summarization models extract words and phrases from a document to form a summary of the document. Prior approaches of abstractive summarization systems tend to hallucinate (generate false information by combining words or phrases incorrectly) at a high frequency. Such hallucinations may broadly be classified as extrinsic, when a model adds information that is not present in the source document, and intrinsic, when the model distorts information present in the source document into a factually incorrect representation.

Neural abstractive text summarization systems, trained by maximizing the likelihood of reference summary given its source document, have been shown to generate plausible summaries. However, recent human analyses and automatic evaluations have shown that the generated summaries tend to contain factual errors (e.g., hallucinations). In addition, higher empirical performance, achieved by other methods, on standard evaluation metrics such as ROUGE score, does not necessarily imply higher faithfulness to the source document. Therefore, there is a need to provide a more factual document summarization system.

### BRIEF DESCRIPTION OF THE DRAWINGS

FIG. 1 is a simplified diagram showing a training method for document summarization according to embodiments.

FIG. 2 provides an example logic flow diagram illustrating an example algorithm for training a document summarization system, according to some embodiments.

FIG. 3 is a simplified diagram of a computing device that performs document summarization, according to some embodiments.

FIGS. 4-8 provide example tables illustrating example performance of different summarization models discussed herein.

FIG. 9 provides example charts illustrating example performance of models with different values of mixing coefficients.

In the figures, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Prior approaches of abstractive summarization systems tend to hallucinate information at a high frequency, resulting in output summaries that fail to accurately reflect the contents of the source documents. Such hallucinations may broadly be classified as extrinsic, when a model adds information that is not present in the source document, and intrinsic, when the model distorts information present in the source document into a factually incorrect representation. Models trained with source summaries that include extrinsic hallucinations tend to generate a higher proportion of extrinsic hallucinations as compared to models trained on cleaner data sets.

Embodiments described herein provide a document summarization framework that controls different factual errors, referred to as “Mixture of Factual Experts (MoFE)” framework. MoFE applies an ensemble of factual expert models to control hallucination in summarization systems. Each factual expert model is trained to generate summaries with a unique type of factual quality, such as low extrinsic hallucinations, or low intrinsic hallucinations. The overall factual quality of MoFE may be achieved by controlling the relative weight of each factual expert. For example, when MoFE have three factual expert models, one optimized for minimal intrinsic factual errors, one optimized for extrinsic factual errors, and one optimized for high informativeness. The three experts may be ensembled (either through logits ensembling, or weighted average of parameters) in order to create a combined output that shares characteristics from each according to its relative weight.

In one embodiment, factual consistency metrics may be used to filter training data in order to adjust the training inputs for each respective expert. For example, a metric may measure the amount of extrinsic errors in a summary. By measuring the extrinsic errors of the summaries in the training data, those with high amounts of extrinsic errors may be filtered out, so that a factual expert may be trained on the remaining summaries to produce an expert model that produces low extrinsic errors.

In one embodiment, the MoFE model may be applied to achieve different quality goals for summarization by applying different weights to each respective factual expert. For example, a specific goal may be to have factual content recall above a certain threshold, while maintaining the least amount of intrinsic and extrinsic hallucinations. By adjusting the relative weights of the experts when they are ensembled, such a goal may be controlled for. After the individual experts are trained, the model may still maintain the flexibility to adjust the weights used during the ensembling process so that the goal may be dynamically adjusted. For example, in some embodiments, when the baseline summarization model does not contain any factual errors in a produced summary (neither intrinsic nor extrinsic errors), the model may ignore the expert models and output the summary produced by the baseline model. Effectively, this is a dynamic adjustment of the weights of the models.

Examples of factual accuracy metrics which may be used include entity overlap for measuring extrinsic hallucinations, and dependency arc entailment (DAE) for measuring intrinsic hallucinations. Entity overlap evaluates the number of entities in summary that are absent from the source document and can be used as a direct measure of extrinsic hallucination. Intrinsic hallucination, on the other hand, is broader and includes errors such as incorrect predicates or their arguments, coreference errors, discourse link errors, etc. Since DAE accuracy measures the fine-grained entailment relations at the dependency arc level, it is a reasonable proxy for measuring intrinsic hallucinations. In one embodiment, both metrics may be used to compute rewards for training experts targeting both types of hallucination.

In one embodiment, MoFE may also include an entity recall-based expert that is trained using both entity overlap and DAE metrics, because experts trained using these two metrics are prone to reducing factual recall.

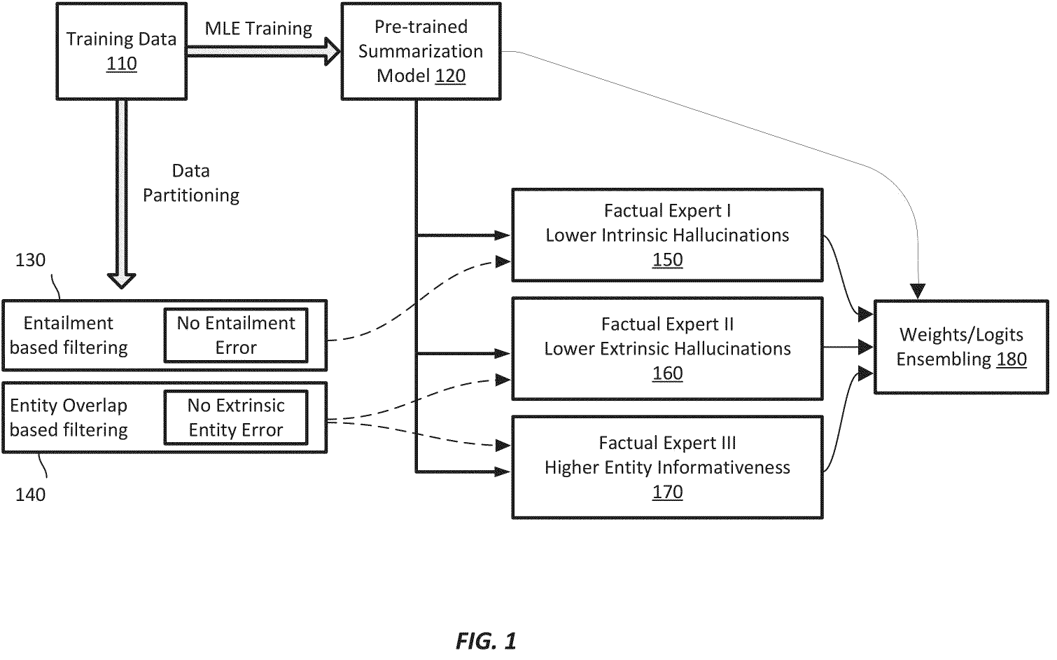

FIG. 1 is a schematic diagram of a method for building a model according to some aspects of the present disclosure. The method has an input of training data 110. The training data may comprise of documents with corresponding summaries or abstracts. Summaries in the training data 110 may include some number of factual errors/hallucinations. The type and degree of a model’s hallucinations correlate with the quality of the training data 110. For example, models trained on the XSum dataset, which includes extrinsic hallucinations in reference summaries, tend to generate a higher proportion of extrinsic hallucination as compared to models trained on the cleaner CNN/DM dataset.

A summarization model is pre-trained on the unfiltered training data 110 using maximum likelihood estimation (MLE) or another method to produce pre-trained summarization model 120. This pre-trained model may be used as the beginning point for training of each of the factual expert models, as indicated by the arrows from the pre-trained summarization model 120 to the factual experts.

Training data 110 is partitioned into multiple subsets which may or may not overlap. Each subset (e.g., 130, 140) may be generated by filtering the training data with a particular factual consistency metric. There are three well-known paradigms for evaluating the factual consistency of summaries generated by a model. The fist is entity overlap precision which includes measuring token-level overlap between the information of interest (e.g., named entities) in the summary and source document. This metric can be used as a proxy to measure simpler cases of hallucinations, such as extrinsic entity errors. The second type of evaluation evaluates if the facts claimed in a summary is entailed by the source document. Two well-known entailment-based metrics include FactCC which measures entailment at the summary-level and DAE which measures fine-level entailment by breaking the summary into smaller claims defined by dependency arcs. DAE correlates with the human judgment of factuality, and has the highest correlation with complex discourse errors, such as entity coreference. The third and most complex methods for evaluating factuality rely on question generation (QG) and question answering (QA). They first use a QG module to generate questions based on summaries and then use another QA module to find answers in the source document. They are computationally expensive to use to train experts, so are not used in examples herein, although these could be used in training factual experts.

The documents and reference summaries in the training data 110 may be analyzed to identify some feature and/or given a score according to some metric such as the ones described above. (In some aspects, the identification of a feature may also be considered a score, i.e., a summary with the feature is scored a 1 and a document without the feature is scored a 0). Document/summary pairs that are identified as having some feature and/or exceed some predetermined threshold may be included in a subset. In some aspects, the training system performs the scoring/identifying step, in other aspects, the training data 110 as provided to the system includes scores for the documents and reference summary pairs. Subset 130 may use entailment-based filtering on training data 110 so that it only includes summaries with no entailment error according to some metric. For example, subset 130 may be produced by measuring dependency arc entailment (DAE) accuracy between the source document and reference summary. Training samples may be filtered where all the dependency arcs in the summary are entailed by the source documents to control intrinsic hallucinations. Subset 140 may use entity overlap based filtering on training data 110 so that it only includes summaries with no extrinsic entity error according to some metric. For example, subset 140 may be produced using SpaCy to identify named entities, and then filter to only include summaries in which all the entity tokens are also mentioned in the source document.

Different partitioned subsets of training data 110 may be used for training/fine-tuning the factual expert models using reinforcement learning (RL). A model which maximizes the log-likelihood of reference summaries can efficiently learn to generate summaries with high n-gram overlap but may fail to learn to enforce factual consistency. Therefore, the training of factual experts may be done by directly optimizing for factual consistency using the self-critic algorithm. Parameters of an expert (θ) may be considered as the policy model, and an action may be defined as predicting the next token in a summary sequence. Given a factual consistency metric M, the method may define the action reward R_{(y,ŷ)} as the score of the generated summary (y) according to M. Here, ŷ is the source document for precision-based factual consistency metrics (e.g., DAE accuracy, entity precision), and the reference summary for fact recall-based metrics (e.g., Entity recall). Further, in accordance with the self-critic training, the method may use the test-time greedy decoding strategy (i.e., argmax) to obtain a summary and calculate the baseline reward R^{a}(_{y,ŷ}). The method may substract the baseline reward from the action-based reward (R_{(y,ŷ)}) and use the resulting reward signal to train the experts. This minimizes the variance of the gradient estimate and importantly adjusts the reward scale to provide both positive and negative values. Overall, the method trains the expert policy to minimize the negative of expected reward difference. For example, a loss may be computed by computing the different between an action reward score, and a baseline reward score. Parameters of the summarization model may be updated based on the computed loss. After Monte Carlo approximation, the loss is computed as:

$${L}_{θ}^{f c} = - {E}_{x} \left[\left({R}_{\left(y , \hat{y}\right)} - {R}^{a} {}_{\left(y , \hat{y}\right)}\right) log {p}_{θ} \left(y \left|x\right)\right)\right]$$

Following standard reinforcement learning-based sequence training formulations, the method initializes the policy model with a text summarization model φ trained on human-annotated datasets. Further to prevent the policy from collapsing to single mode o significantly deviating away from φ, the model adds an additional KL divergence loss (eq. 2) between the next token probabilities of the policy θ and baseline φ. The model trains experts using the weighted sum of the two losses

$$λ {L}_{θ}^{f c} + ( \left(1 - λ\right) {L}_{θ}^{k l} .$$

For example, the divergent loss is computed by comparing the divergence between a summary generated by a baseline model and a summary generated by a fine-tuned summarization model. Specifically, the loss may be based on a divergence between next token probabilities of the baseline summarization model and the fine-tuned summarization model. Such a loss may be represented as follows.

$${L}_{θ}^{k l} = {E}_{x} \left[{p}_{ϕ} \left({y}^{∗} \left|x\right)\right) l o g \left({p}_{ϕ} \left({y}^{∗} \left|x\right)\right) / {p}_{θ} \left({y}^{∗} \left|x\right)\right)\right)\right]$$

Equations 1 and 2 describe the general framework for training experts according to embodiments herein. In equation 2, y* is chosen depending on the number of factual errors in training samples. Human-written reference summaries are generally more natural and preferable than the summaries generated by a summarization model. So, on training samples that do not contain factual errors (filtered training samples), the reference summary may be used as y*. On the contrary, when the dataset contains frequent factual errors, minimizing KL divergence with respect to reference summary encourages the model to continue to uniformly increase probability mass on factually inconsistent references. This may lower the gain from reward-based loss. Therefore, when factual quality of training data is indeterminable, summaries sampled following probabilities from then expert (policy) model may be used as y*. Using reference summary on factually consistent training data is suitable for training experts that aim to improve factual consistency. However, data filtering reduces the number of samples. Given this training data size vs factual quality trade-off, different experts may be trained differently. For example, performing data filtering followed by RL training to build experts that target content-precision metrics, and empirically determining data filtering and mode of RL training for recall-related experts. In some embodiments, factual experts are trained using MLE with filtered training data rather than RL. For example, an expert targeting low intrinsic hallucinations may be trained using MLE loss on a training data subset filtered using the DAE metric.

As illustrated in this example, factual expert I 150 is trained for the goal of lower intrinsic hallucinations, and this goal is approached by using the subset 130 which contains no entailment errors. Factual expert II 160 is trained for the goal of lower extrinsic hallucinations, and this goal is approached by using the subset 140 which contains no extrinsic entity errors. Factual expert III 170 is trained for the goal of higher entity informativeness, and this goal is approached by using the subset 140. Although trained with the same subset 140 as factual expert II 160, factual expert III 170 is trained to maximize recall of salient entities between the generated summary and the reference summary. In some aspects, factual expert III may be trained using a separate subset of training data 110 which is filtered using a specific informativeness metric. In some embodiments greater or fewer factual experts may be trained based on different goals/metrics.

The factual experts 150, 160, and 170, and in some aspects the pre-trained summarization model 120, may be combined through either weights or logits ensembling 180 to generate a composite output. The mixing weights/coefficients for all expert models 150, 160, and 170, and pre-trained summarization model 120 are used to control the factual quality of summaries generated by the ensemble model. For example, a user may determine that the ensembled model should have a certain level of intrinsic hallucinations, extrinsic hallucinations, and informativeness. By adjusting weights either manually or automatically by a system, a user may tune the ensembled model to meet the specified goal. For example, in some contexts, it may be more desirable to have the ensembled model produce summaries with high informativeness even at the cost of high intrinsic hallucinations, while in other contexts it may be more desirable to have the ensembled model produce summaries with low intrinsic and extrinsic hallucinations at the cost of informativeness.

For weights ensembling, the method may use the element-wise weighted average of all the parameters of pre-trained summarization model 120 and expert models 150, 160, and 170. The result of weights ensembling is a single composite model, which in effect reduces the memory and processing needed for using the model when decoding since the multiple models have been collapsed to a single mode. The weights used for each model, however, are determined at the time of ensembling, and may be more difficult to change later as the individual models may no longer be available. The weights used during weights ensembling may be determined based on a predefined factual quality goal. Weights may be applied to the respective summarization models being ensembled in order to control how each respective summarization model contributes to the combined summarization model.

For logits ensembling, the method may use the weighted average of logits from all the experts 150, 160, and 170, and the pre-trained summarization model 120 during decoding. Each model is still used individually during decode, allowing for weights of each model to be adjusted more dynamically.

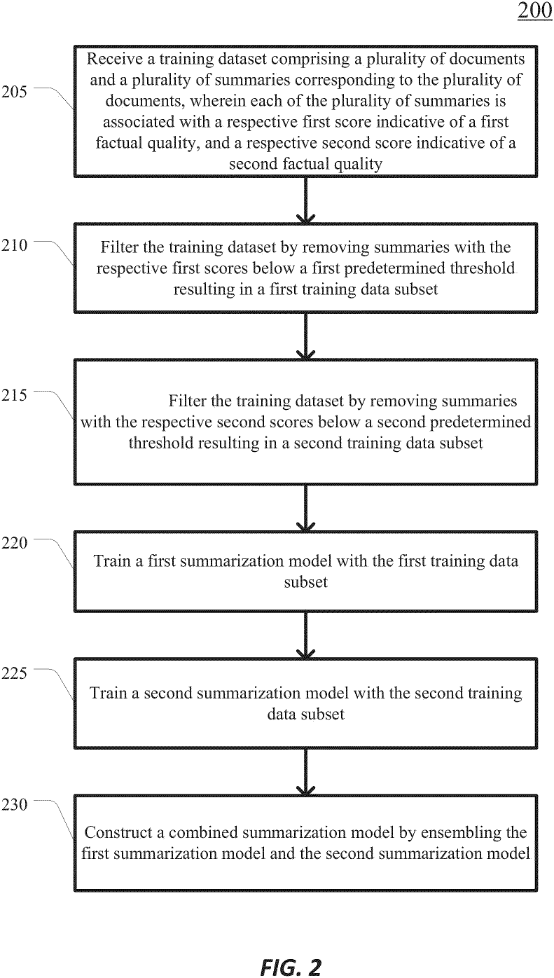

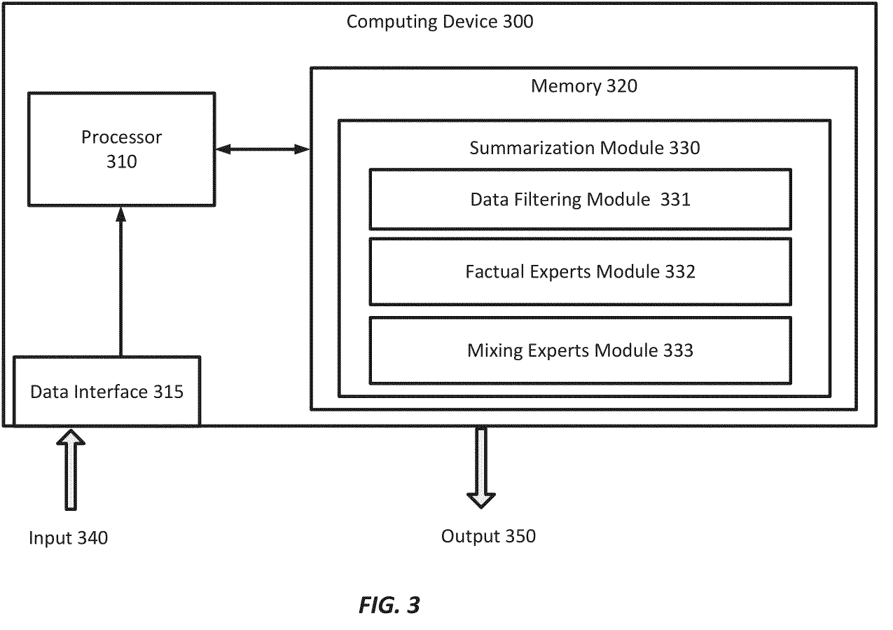

FIG. 2 provides an example logic flow diagram 200 illustrating an example algorithm for training a document summarization system, according to some embodiments. One or more of the processes described in FIG. 2 may be implemented, at least in part, in the form of executable code stored on non-transitory, tangible, machine-readable media that when run by one or more processors may cause the one or more processors to perform one or more of the processes 205-230. In some embodiments, method 200 may correspond to the method used by the module 330 in FIG. 3.

At step 205, the system receives a training dataset comprising a plurality of documents and a plurality of summaries corresponding to the plurality of documents, wherein each of the plurality of summaries is associated with a respective first score indicative of a first factual quality, and a respective second score indicative of a second factual quality. As discussed above, the score associated with the plurality of summaries may be a score based on a metric or may be the identification of a feature such as every summary token also being in the source document. In some aspects, the score is received with the training dataset, and in other aspects the system determines the score.

At step 210, the system filters the training dataset by removing summaries with the respective first scores below a first predetermined threshold resulting in a first training data subset. For example, the dataset may be filtered for the goal of lower intrinsic hallucinations by only including summaries which contain no entailment errors according to some metric.

At step 215, the system filters the training dataset by removing summaries with the respective second scores below a second predetermined threshold resulting in a second training data subset. For example, the system may use entity overlap based filtering on the training dataset so that it only includes summaries with no extrinsic entity error (i.e., extrinsic hallucinations) according to some metric.

At step 220, the system trains a first summarization model with the first training data subset. The first summarization model may start with a generic pre-trained summarization model, for example trained on the entire unfiltered dataset. Based on how the training data subset was formed and the training method, the first summarization model may target a specific factual accuracy/informativeness goal.

At step 225, the system trains a second summarization model with the second training data subset. Similar to the first summarization model, the second summarization model may start with the same generic pre-trained summarization model, for example trained on the entire unfiltered dataset. Based on how the training data subset was formed and the training method, the second summarization model may target a specific factual accuracy/informativeness goal.

At step 230, the system constructs a combined summarization model by ensembling the first summarization model and the second summarization model. As discussed above, the ensembling may be through either weights or logits ensembling. By adjusting the weights of each of the summarization models in the ensembling, different goals may be achieved in the composite output of the ensembled model.

FIG. 3 is a simplified diagram of a computing device that implements the multi-document summarization, according to some embodiments described herein. As shown in FIG. 3, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for a Summarization module 330 that may be used to implement and/or emulate the systems and models, and/or to implement any of the methods described further herein. In some examples, the Summarization module 330, may receive an input 340, e.g., such as a document on a particular topic, via a data interface 315. The Summarization module 330 may generate an output 350, such as a summary of the input 340.

In some embodiments, the Summarization module 330 may further include the data filtering module 331, factual experts module 332, and a mixing experts module 333. The data filtering module 331 is configured to filter training data as described above. The filtering module 331, for example, may produce multiple subsets of training data based on different metrics such as low extrinsic hallucinations or low intrinsic hallucinations.

The factual experts module 332 is configured to train a number of factual experts optimized based on factual accuracy metrics. By using different subsets of the training data as filtered by the filtering module 331, and using different training methods, different goals may be achieved by different factual experts. For example, one factual expert may produce summaries that have low intrinsic hallucinations, and another factual expert may produce summaries that have low extrinsic hallucinations.

The mixing experts module 333 is configured combine the factual experts and in some aspects a pre-trained summarization model through weights or logit ensembling as described above. The trained model may then output a summary based on an input document based on the ensembled model. By adjusting the weights of the different models during ensembling, the output summary may be adjusted to achieve certain goals that is determined by a user. For example, by weighting more the factual expert that is trained for low extrinsic hallucinations, the output summary may thereby be optimized for low extrinsic hallucinations. Goals that are more nuanced with combinations of goals may be accomplished by ensembling with different weights so that the combined output that shares characteristics from each expert according to its relative weight.

Some examples of computing devices, such as computing device 300 may include non-transitory, tangible, machine readable media that include executable code that when run by one or more processors (e.g., processor 310) may cause the one or more processors to perform the processes of methods described herein. Some common forms of machine readable media that may include the processes of methods described herein are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

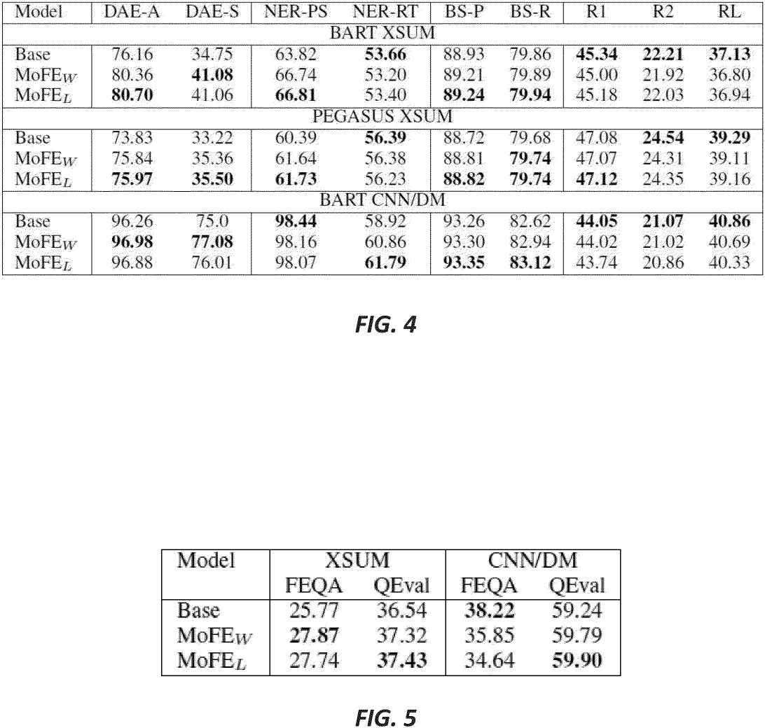

FIG. 4 provides an example table illustrating example performance of different summarization models discussed herein. In addition to the base model MOFE, two variants were tested, MOFEw which uses weights ensembling, and MOFE_{L} which uses logits ensembling. Models compared against include BART, described in Lewis et al., BART: Denoising sequence-to-sequence pre-training for natural language generation, translation, and comprehension, Proceedings of the 58^{th} Annual Meeting of the Association for Computational Linguistics, pages 7871-7880, 2020. Also. One BART model in the comparison was trained on XSUM data, as described in Narayan et al., Don’t give me the details, just the summary! Topic-aware convolutional neural networks for extreme summarization, Proceedings of the 2018 Conference on Empirical Methods in Natural Language Processing, pages 1797-1807, 2018. The other BART model was trained on the CNN/DM dataset described in Hermann et al., Teaching machines to read and comprehend, CoRR, abs/1506.03340, 2015. A Pegasus model trained on XSUM data is also in the comparison, as described in Zhang et al., Pegasus: Pre-training with extracted gap-sentences for abstractive summarization. Metrics included in the comparison include DAE-A and DAE-S as described in Goyal et al., Evaluating factuality in generation with dependency-level entailment, Findings of the Association for Computational Linguistics, EMNLP, pages 3592-3603, 2020. Specifically, the table in FIG. 4 illustrates DAE accuracy, entity precision with respect to source (NER-PS), entity recall (NER-RT) and ROUGE scores for the base and MoFE models on XSUM and CNN/DM datasets. ROUGE score is described in Lin, ROUGE: A package for automatic evaluation of summaries, Text Summarization Branches Out, pages 74-81, 2004. R1/R2/RL are ROUGE-1/2/L respectively. BERTScore-P (BS-P) is used to measure precision, and BERTScore-R (BS-R) is used to measure recall with respect to source, as described in Zhang et al., Bertscore: Evaluating text generation with bert, International Conference on Learning Representations, 2019b. Both MoFEw and MoFE_{L} outperform BART and PEGASUS across all factual consistency metrics on the XSUM dataset. Similarly, both models outperform BART on CNN/DM dataset with marginal degradation on entity precision (NER-P). This is unsurprising given BART is consistent against extrinsic entity hallucination on CNN/DM (NER-PS of 98.44) and has a very small room for improvement. This aligns with the findings from a human evaluation that the BART model has very few extrinsic entity errors. Next, neither of the MoFE models lowers ROUGE scores substantially on either of the XSUM or CNN/DM datasets, the worst being 0.53 drop on ROUGE-L for MoFE_{L} on CNN/DM. MoFE models improve BERTScore precision (BS-P) and recall (BS-R) with respect to the source article on both XSUM and CNN/DM datasets.

Between logits and weights ensembling, both perform comparably on factual consistency metrics. However, by calculating logits for all experts and the pre-trained model at each decoding step, logit ensembling increases the decoding time linearly with the number of experts. Weights ensembling, on the other hand, does not increase the inference time and provides a lightweight method for combining experts. Accordingly, for fair comparison with the base model, the table in FIG. 4 uses MoFEw in its analysis.

FIG. 5 provides an example table illustrating example performance of different summarization models discussed herein. Specifically, the table in FIG. 5 illustrates Q metrics-based evaluations of BART and corresponding MoFE models. MoFE models improve on the QAbased QuestEval metric on both XSUM and CNN/DM datasets. However, both MoFE_{w} and MoFE_{L} perform much worse than the BART model on the FEQA metric for CNN/DM data. FEQA is described in Durmus et al., FEQA: A question answering evaluation framework for faithfulness assessment in abstractive summarization, Proceedings of the 58^{th} Annual Meeting of the Association for Computational Linguistics, pages 5055-5070, 2020. The contrasting observations between FEQA and QuestEval may be explained by the variation in question-generation (QG) modules used in both metrics. QuestEval is described in Scialom et al., Questeval: Summarization asks for fact-based evaluation, arXiv preprint arXiv:210312693, 2021. The QG model used in FEQA tends to copy the entire summary into the questions (e.g., “when is the sigma alpha epsilon fraternity fighting back against claims that racism is stitched into the fabric of the fraternity? one of the University of Oklahoma students who took part in the infamous racist chant wrote that ‘the song was taught to us”’). This behavior does not pose serious problems for shorter summaries, like those in the XSUM. However, for longer summaries, questions become abruptly complicated for the QA model to find the correct answer in the source document (e.g., QA model answers this question by selecting the bolded phrase “...racism is stitched into the fabric of the fraternity - by mandating that all members of the organization undergo diversity training”). On the other hand, the QG model in the QuestEval generates straightforward questions (e.g., “When did the executive director announce changes to the Sigma Alpha Epsilon fraternity?”).

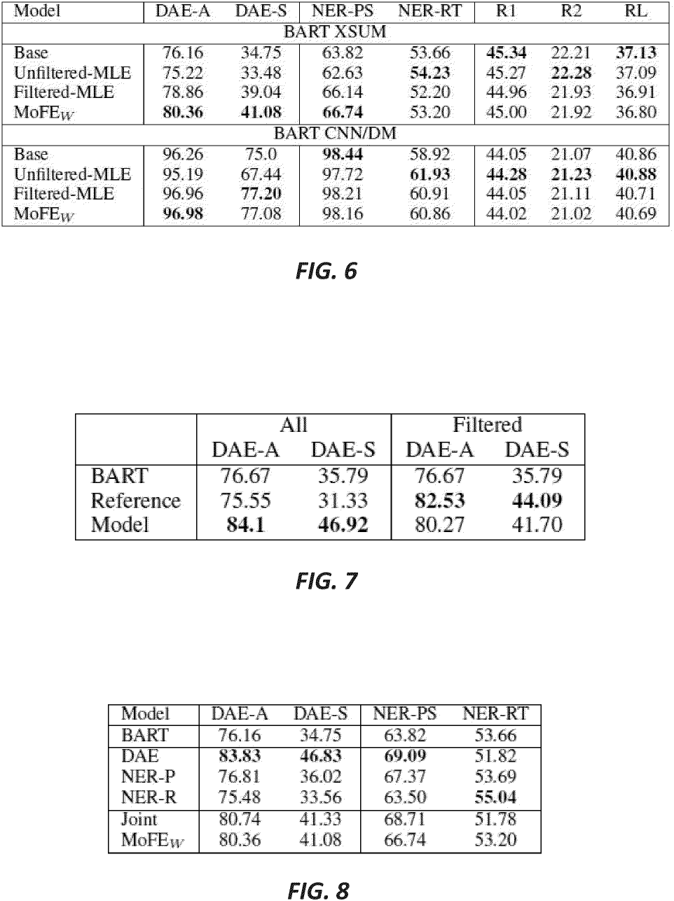

FIG. 6 provides an example table illustrating example performance of different summarization models discussed herein. Specifically, the table in FIG. 6 illustrates the results of an ablation study evaluating how training data filtering and RL-based training contribute to the improved performance of MoFE. The table of FIG. 6 includes DAE accuracy, entity precision, entity recall and ROUGE scores for different weight-ensembled models on XSUM and CNN/DM datasets. Unfiltered-MLE is an ensemble of four BART models, including the best performing base, and Filtered-MLE is an ensemble of experts, trained exclusively with the MLE loss on corresponding filtered data, and the base model. First, ensembling multiple BART models improves ROUGE scores and NER recall, but not factual consistency metrics defined by DAE accuracy and NER precision. On the other hand, Filtered-MLE ensemble consistently outperforms both Base and Unfiltered-MLE models on factual consistency metrics, underlining the importance of using factually correct samples during training. MoFEw model, that is based on RL training to directly optimize factual consistency, further improves the performance on XSUM data. However, on CNN/DM data, MoFEw and Filtered-MLE perform comparably.

FIG. 7 provides an example table illustrating example performance of different summarization models discussed herein. Specifically, the table in FIG. 7 illustrates performance of DAE experts trained with reference and sampled summary (Model)-based KL loss on all training data and filtered subset of training data. Both variants of experts improve performance on DAE-A/S metrics when trained on the filtered subset. However, the margin of improvement is higher for reference-based experts, implying the advantage of minimizing KL divergence on reference summary when training samples are free from factual errors. On the whole training data that includes factually inconsistent samples, reference-based experts degrade the performance on DAE-A/S metrics. On contrary, experts minimizing KL divergence on sampled summary are effective, outperforming reference-based DAE expert trained on filtered subset by 1.57% and 2.83% on DAE-A and DAE-S metrics respectively. Overall, empirical results reiterate that factual quality of training data affects the performance of experts. On factually consistent samples, the method can use either of the reference or sampled summary to define KL divergence loss. However, when samples contain factual errors, reference summary may not be effective.

FIG. 8 provides an example table illustrating example performance of different summarization models discussed herein. Specifically, the table in FIG. 5 illustrates DAE accuracy, entity precision and entity recall of individual experts on XSUM data. First, all three experts outperform the BART model, on their respective factual consistency metric. Importantly, DAE expert performs better than (or comparable to) NER-P expert on NER-PS metric. Dependency arc error subsumes extrinsic entity error as dependency arcs corresponding to extrinsic entities cannot be entailed by the source document. This is a desirable behavior given there is not a need to train multiple experts if the right set of reward function/metric can be chosen. The Joint model that uses average of DAE, NER-P and NER-R rewards and trains on data filtered according to all three metrics, perform slightly better than MoFEw on DAE-A/S and NER-PS metric. However, it obtains 1.42 points lower entity recall as well as performs consistently worse than the DAE expert across all metrics. Notably, MoFEw has the flexibility to include multiple experts and adjust for degradation in performance on any metric by including an appropriate expert during the decoding time. Therefore, joint model can also be used as a new expert in MoFE and resulting degradation in NER recall can be adjusted by the NER-R expert.

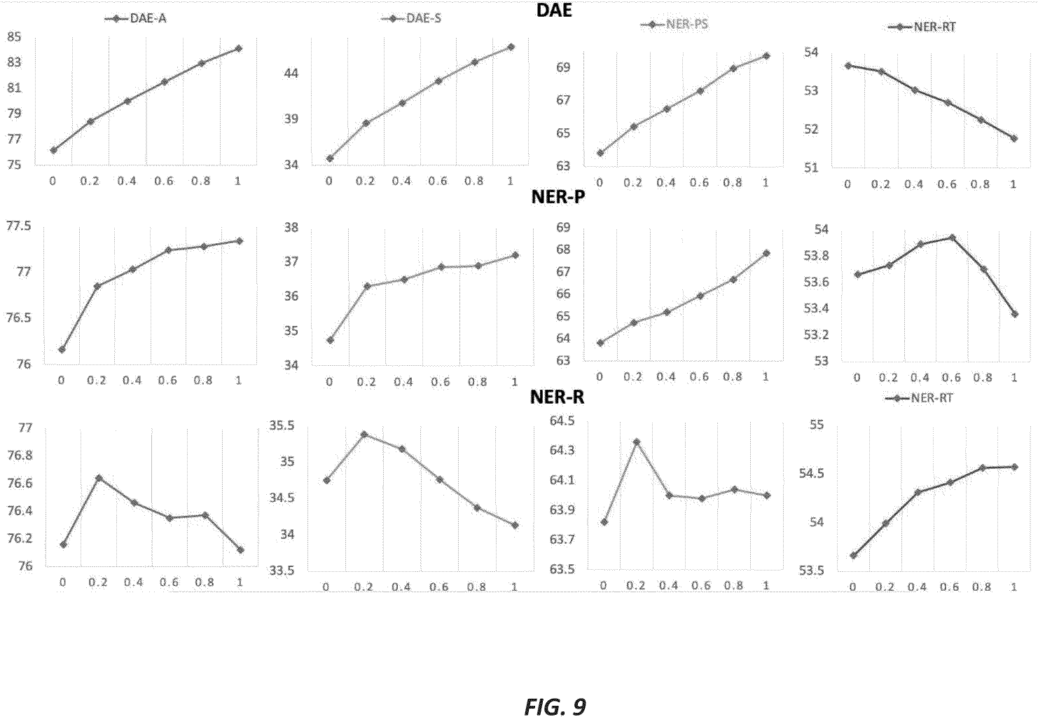

FIG. 9 provides example charts illustrating example performance of models with different values of mixing coefficients. Specifically, the charts in FIG. 9 illustrate variations in the performance of weight-ensembled expert and BART models with different values of mixing coefficient α (α=0.0 corresponds to only BART model, and α = 1.0 corresponds to only expert model.) for different expert models. Each expert and the BART model were combined with different mixing coefficients (α) and the resulting plots of their performance on XSUM validation data are illustrated. Weights ensembling was used for the charts in FIG. 9 and models evaluated on DAE-A/S and NER-PS/RT metrics. First, the performance of the ensemble of expert and BART model on the respective metric roughly lies on the linear line connecting the performance of the individual expert and BART models. On the metrics that are not part of expert training, the performance of the ensemble model either remains approximately unchanged (e.g., DAE-A, NER-PS metrics for the NER-R expert) or lies on the linear line (e.g., NER-PS/RT metrics for the DAE expert). Given the linear dependence, the mixing coefficient may be selected for an expert depending on the tolerance value for the ensemble model on all metrics. Further, the reduction in performance of the ensemble model on any metric can be compensated for by training an expert targeting that specific metric. For instance, to compensate for the reduction in performance of the ensemble of DAE and BART on the NER-RT metric, an NER-R expert may be added that obtains higher NER recall than the base BART model. Note that, the modular characteristics of MoFE also allows for the selection of different values of mixing coefficients for each of the experts and BART model depending on the significance of different factual errors in the target application.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for controlling factual accuracy in abstractive summarization models, the method comprising:
receiving a training dataset comprising a plurality of documents and a plurality of summaries corresponding to the plurality of documents,
wherein each of the plurality of summaries is associated with a respective first score indicative of a first factual characteristic quality, and a respective second score indicative of a second factual characteristic quality;
filtering the training dataset by removing summaries with the respective first scores below a first predetermined threshold resulting in a first training data subset;
filtering the training dataset by removing summaries with the respective second scores below a second predetermined threshold resulting in a second training data subset;
training a first summarization model with the first training data subset;
training a second summarization model with the second training data subset; and
constructing a combined summarization model by ensembling the first summarization model and the second summarization model.

2. The method of claim 1, wherein the first factual characteristic quality is a measurement of dependency arc entailment (DAE) accuracy between a document and a respective reference summary.

3. The method of claim 1, wherein the second factual characteristic quality is a measurement of a number of entity tokens in a summary not present in a respective document.

4. The method of claim 1, further comprising:
determining, based on a predefined factual quality goal, a first weight for the first summarization model and a second weight for the second summarization model, wherein the first and second weights control how the first summarization model or the second summarization model contributes to the combined summarization model.

5. The method of claim 4, further comprising:
determining an element-wise weighted average of first parameters of the first summarization model and second parameters of the second summarization model using the first weight and the second weight respectively.

6. The method of claim 4, further comprising:
in response to an input document for summarization:
generating, by the first summarization model, a first logit output;
generating, by the second summarization model, a second logit output; and
determining a weighted average of the first logit and the second logit using the first weight and the second weight, respectively.

7. The method of claim 4, wherein the first weight and the second weight are dynamically adjusted based on a determination that a summary produced by a baseline summarization model does not contain factual errors,
wherein the baseline summarization model is trained on unfiltered data.

8. The method of claim 1, further comprising:
computing an action reward score based on a summary generated by the first summarization model;
computing a baseline reward score;
computing a first loss based on the difference of the action reward score and the baseline reward score; and
updating parameters of the first summarization model based on the first loss.

9. The method of claim 8, further comprising:
initializing the first summarization model based on a baseline summarization model;
computing a second loss based on a divergence between next token probabilities of the baseline summarization model and the first summarization model; and
updating parameters of the first summarization model based on the second loss.

10. The method of claim 1, wherein training the first summarization model comprises:
training the first summarization model using a maximum likelihood estimation based on the first training data subset.

11. The method of claim 1, further comprising:
training a third summarization model with the second training data subset with an objective of entity informativeness; and
constructing a combined summarization model by ensembling the first summarization model, the second summarization model, and the third summarization model.

12. A system for controlling factual accuracy in abstractive summarization models, the system comprising:
a memory that stores a summarization model;
a communication interface that receives a plurality of documents and a plurality of summaries corresponding to the plurality of documents, wherein each of the plurality of summaries is associated with a respective first score indicative of a first factual characteristic quality, and a respective second score indicative of a second factual characteristic quality; and
one or more hardware processors that:
filters the training dataset by removing summaries with the respective first scores below a first predetermined threshold resulting in a first training data subset;
filters the training dataset by removing summaries with the respective second scores below a second predetermined threshold resulting in a second training data subset;
trains a first summarization model with the first training data subset;
trains a second summarization model with the second training data subset; and
constructs a combined summarization model by ensembling the first summarization model and the second summarization model.

13. The system of claim 12, wherein the first factual characteristic quality is a measurement of dependency arc entailment (DAE) accuracy between a document and a respective reference summary.

14. The system of claim 12, wherein the second factual characteristic quality is a measurement of a number of entity tokens in a summary not present in a respective document.

15. The system of claim 12, wherein the one or more hardware processors further:
determines, based on a predefined factual quality goal, a first weight for the first summarization model and a second weight for the second summarization model, wherein the first and second weights control how the first summarization model or the second summarization model contributes to the combined summarization model.

16. The system of claim 15, wherein the one or more hardware processors further:
determines an element-wise weighted average of first parameters of the first summarization model and second parameters of the second summarization model using the first weight and the second weight respectively.

17. The system of claim 15, wherein the one or more hardware processors further:
in response to an input document for summarization:
generates, by the first summarization model, a first logit output;
generates, by the second summarization model, a second logit output; and
determines a weighted average of the first logit and the second logit using the first weight and the second weight, respectively.

18. The system of claim 12, wherein the one or more hardware processors further:
computes an action reward score based on a summary generated by the first summarization model;
computes a baseline reward score;
computes a first loss based on the difference of the action reward score and the baseline reward score; and
updates parameters of the first summarization model based on the first loss.

19. The system of claim 18, wherein the one or more hardware processors further:
initializes the first summarization model based on a baseline summarization model;
computes a second loss based on a divergence between next token probabilities of the baseline summarization model and the first summarization model; and
updates parameters of the first summarization model based on the second loss.

20. The system of claim 12, wherein the one or more hardware processors further:
trains a third summarization model with the second training data subset with an objective of entity informativeness; and
constructs a combined summarization model by ensembling the first summarization model, the second summarization model, and the third summarization model.
